(19) United States
(12) Patent Application Publication
(10) Pub. No.: US 2022/0351180 A1
(43) Pub. Date: Nov. 3, 2022

(54) Computer Implemented System and Method for Touchless Parking Entry, Payment, and Exit from Parking Facility, and Computer-Readable Medium Having Processor-Executable Instructions For Same

(71) Applicant: ParkEngage Inc., Milpitas, CA (US)

(72) Inventors: Rajiv Jain, Milpitas, CA (US); Joseph Parker, Aliquippa, PA (US)

(21) Appl. No.: 17/734,060

(22) Filed: Apr. 30, 2022

Related U.S. Application Data
(60) Provisional application No. 63/182,455, filed on Apr. 30, 2021.

(51) Int. Cl. G06Q 20/32; G06Q 20/42; G06K 7/14

(52) U.S. Cl. CPC G06Q 20/3276; G06Q 20/3255; G06Q 20/42; G06K 7/1417; G06Q 2240/00

(57) ABSTRACT

A computer-implemented system includes a platform cloud server, and platform application software executable by the platform cloud server, the platform application software configured to close an access control gate to prevent a subject vehicle from exiting a secured vehicle parking facility at said access control gate unless an exit condition is satisfied, the exit condition including identity of the subject vehicle, receipt of an exit request to exit through the gate by touchless initiation, and actual receipt of payment by touchless initiation. A QR code is displayed to present the exit request, and a touchless vehicle detection system determines identity of the subject vehicle.

### CROSS REFERENCE TO RELATED APPLICATIONS

This application is related and claims priority to U.S. Provisional Application 63/182,455 filed Apr. 30, 2021 entitled Touchless Parking Entry, Payment, and Exit from Parking Facility, which is hereby incorporated by reference in entirety.

### FIELD OF THE INVENTION

The disclosure relates generally to systems, apparatus and methods for parking facilities allowing users to be able to seamlessly use the facilities to park their vehicles in a safe and efficient manner. The disclosure also relates to systems and methods for touchless parking. More particularly, the present disclosure is in the area of allowing parking technology automation while enhancing the safety, convenience and user experience in general.

### BACKGROUND OF THE INVENTION

Current parking facilities or parking garages (“parking facility” or “facility”) generally require either an attendant to provide an entry ticket and collect payment from consumers using the facility, provide kiosk type structures where a user may make payment and display a payment receipt on the dashboard, or allow for gate operation through use of a machine where the user takes a ticket and make payment using similar system with credit card or cash on exit.

Some parking systems allow users to have a subscription service and allow for either a card that can be read by a card reader at entrance or provide a tag to be mounted on the vehicle that can operate the gate through sensors. Traditional systems require the user to either interact with another person, or obtain a ticket or a receipt to complete the transaction. This is especially true for systems which do not have a subscription service with related automation in the form of a tag or card which is always in user's possession or on the user's vehicle. The traditional systems can often take additional time in entering and exiting the facilities and often involve multiple touch points for a user. The experience can be improved by utilizing almost a ubiquitous device that most consumers now carry on them—their smart phone. The recent COVID pandemic has also resulted in enhanced requirements by users to their safety by having as few touch points as possible.

For reasons stated above and for other reasons which will become apparent to those skilled in the art upon reading and understanding the present specification, there is a need in the art for improved systems and methods for parking facilities and parking structures.

### BRIEF DESCRIPTION OF THE INVENTION

The above-mentioned shortcomings, disadvantages and problems are addressed herein, as will be understood by those skilled in the art upon reading and studying the following specification.

This Summary is provided to introduce a selection of concepts in a simplified form that are further described below in more detail in the Detailed Description. This Summary is not intended to identify key or essential features of the claimed subject matter.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In one aspect, systems, apparatus, and methods are provided through which the above objective of minimizing touches while parking a vehicle and enhancing the user experience, efficiency of the transaction and minimizing the time needed for entry and exit may be achieved.

It will be understood that the terminology used in this application may also encompass terms such as touchless parking, frictionless parking, ticketless parking, mobile parking, mobile payments for parking and other similar terms.

The disclosed subject matter may enable parking customers to enter, pay for, and exit a parking facility without the need to handle paper tickets, cash, or credit cards, without having to interact with attendants, cashiers, or payment machines, without having to wait in lines with other customers to pay, and in general to be able to park, pay, and exit while preserving social distancing and minimizing the possibility of being exposed to or transmitting germs with other customers or employees of the parking facility.

The disclosed subject matter may include an electronic, software system that is designed to operate in a cloud based, Software as a Service (SaaS) model and that customers may access via their smart phone or tablet device with or without the need to install a proprietary mobile application in order to use the service. The system is designed to work with any of the parking operator's gating system through the internet or local area network in order for the system to be able to open the gate to provide customer entry and egress.

All of the end-user functionality that is provided as part of systems disclosed herein may be accessed by a mobile smart device possessing a mobile web browser and having internet access and SMS service. The cloud system provides all of the functionality described below via API call and in this way the end-user functionality may also be accessed through any other application or technology that incorporates the appropriate API calls.

In addition to the customer facing mobile system as described above, a system may include cloud-based administrative functionality as well to enable the administrator to monitor customer usage, open and close gates, take customer payment, and manage and report on customer activities remotely without needing to interact face-to-face with the customer.

Apparatus, systems, and methods of varying scope are described herein. These aspects are indicative of various non-limiting ways in which the disclosed subject matter may be utilized, all of which are intended to be within the scope of the disclosed subject matter. In addition to the aspects and advantages described in this summary, further aspects, features, and advantages will become apparent by reference to the associated drawings, detailed description, and claims.

### BRIEF DESCRIPTION OF THE DRAWINGS

The disclosed subject matter itself, as well as further objectives, and advantages thereof, will best be illustrated by reference to the following detailed description of embodiments of the methods and systems read in conjunction with the accompanying drawings, wherein:

FIG. 1 is a simplified block diagram of a computer-implemented system in an exemplary embodiment;

FIG. 2 is a simplified block diagram of a computer-implemented system including messaging (SMS) gateway architecture in an exemplary embodiment;

FIGS. 3A and 3B illustrate a simplified flow chart of a computer-implemented system including architecture for direct check-in and check-out using SMS type QR code without prepaid booking, in an exemplary embodiment;

FIGS. 4A and 4B illustrate a simplified flow chart of a computer-implemented system including architecture for direct check-in and check-out using SMS type QR code with prepaid booking, in an exemplary embodiment;

FIGS. 5A and 5B illustrate a simplified flow chart of a computer-implemented system including architecture for direct check-in and check-out using Web URL type QR code without prepaid booking, in an exemplary embodiment;

FIGS. 6A and 6B illustrate a simplified flow chart of a computer-implemented system including architecture for direct check-in and check-out using Web URL type QR code with prepaid booking, in an exemplary embodiment; and

FIG. 7 is a simplified flow diagram illustrating a method for touchless parking entry, payment, and exit from a parking facility in an exemplary embodiment.

### DETAILED DESCRIPTION OF THE INVENTION

In the following detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. It is further to be understood that some of the embodiments refer to use of certain software and application services that may be interchangeable with other similar or even dissimilar applications that may provide the support for the needed functionality. In view of the foregoing, the following detailed description is not to be taken as limiting the scope of the embodiments or disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

The detailed description set forth herein in connection with the appended drawings is intended as a description of exemplary embodiments in which the presently disclosed apparatus and system may be practiced. The term “exemplary” used throughout this description means “serving as an example, instance, or illustration,” and should not necessarily be construed as preferred or advantageous over other embodiments.

Parking in commercial facilitys is an antiquated and cumbersome process. Most of the commercial self-parking and valet facilitys charge customers to park into their facility. In most of the self-parking facilitys, when a customer arrives at the facility entry gate, a paper ticket is dispensed to the customer from a ticketing machine or a paper ticket is handed over to the customer by a human attendant. This process is very inefficient because to collect the paper ticket a customer needs to interact with a machine or a human. This leads to risk of customer catching the germs, for example during COVID19 pandemic COVID virus infections, from the ticket machine surfaces or from human to human transmission. In addition, customers tend to misplace the paper tickets leading to further inconveniences and delays when they come back to retrieve their car. Further paper ticket is environmentally unfriendly due to use of a physical paper.

Furthermore, when they return back to retrieve their car, they often need to stand in the line at a pay machine, or in line for a human cashier, or fumble at the exit gates to pay the attendant or a pay machine by cash or by providing their credit cards. This not only exposes them to potential risk of catching the germs, but it also causes them significant wait times in the lines, leading to significant inconveniences and overall poor parking experience.

If it is a valet facility then they have to wait for the attendants to check them in, and attendant to physically collect the keys from the customer, and hand over the paper ticket. This is very risky for the customer as well as the attendant because both have to come into physical contact which often violates the social distancing protocols, as well as leads to needless and unfamiliar objects and surfaces touched. When the customers return to retrieve their car, they have to wait in the facility along with other customers in close proximity while valet brings their car out. If customer is happy with valet's service then they may like to tip the valet, which often is done with cash, leading to further human to human interaction and all risks and inconvenience to both the customers and the valets.

Other challenges are that with high demand of parking spaces, some customers prefer to reserve the parking spot for themselves before they arrive at the facility. These reservations could be made few hours to few days in advance. Furthermore, customers have various options available for them to make these reservations, such as, they may make the reservation directly with the facility, or 3rd party resellers, or various business partners of the facility, e.g. Zoos, Theaters, Sports Stadiums, Hospitals, etc., or from the parking aggregators. With so many different options available it becomes very hard, and often manual, process for the facilitys to provide a seamless parking experience to the customers.

With the customers becoming more mobile, and more dependent on their smart phones, they expect a touchless parking experience where neither have to interact with any machine or human, nor want to receive or keep track of any physical paper ticket. They also want a seamless experience regardless of whether they are arriving at the facility with or without a reservation, and regardless of how they have reserved the parking. If the reservation is prepaid then they want the facility to recognize that and honor that payment rather than needing a human cashier to verify their prepaid reservations.

From the facility's point of view the challenges include that some of the facilitys have heavy investments in the legacy parking and revenue control systems (PARCS), they already have entry and exit gates installed, and now they want to provide this touchless experience to their customers while not throwing away investments in these legacy systems. Also, they want to fully automate their facilitys with minimum need for facility staff. Furthermore, they desire safety of their essential staff from the potential risks of catching germs from their customers and vice versa. In addition, they also want secure systems that may also allow them to collect their parking revenues instantly and want a system that is temper proof.

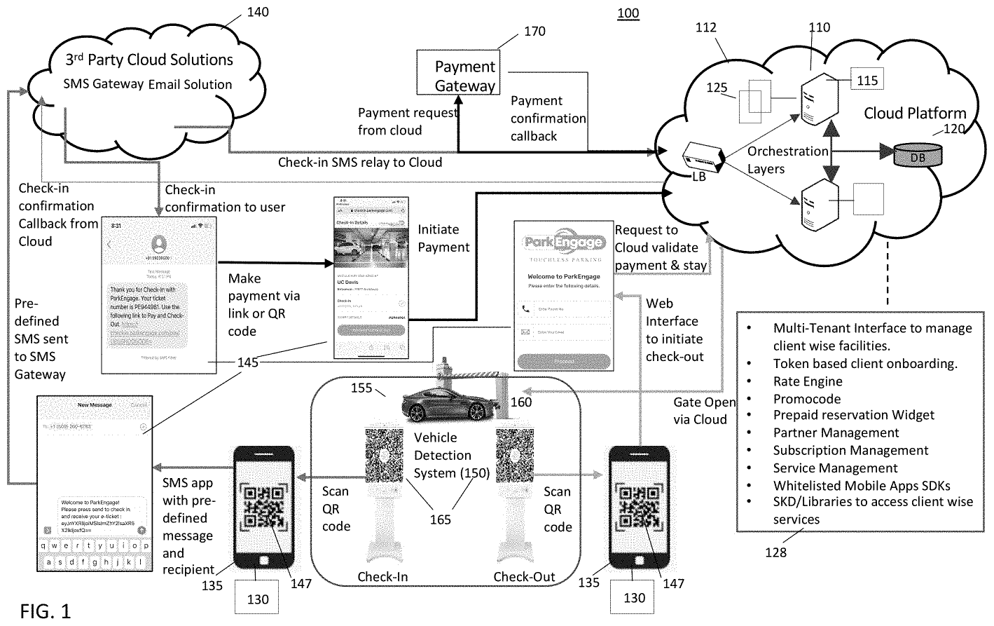

FIG. 1 is a simplified block diagram of a computer-implemented system 100 (“system 100”) for touchless payment, entry, and exit from a parking facility, in an exemplary embodiment. FIG. 1 illustrates exemplary system architecture of system 100, which in an embodiment may include a platform cloud server 110 accessible over a network 112 such as the Internet, such as by a browser. Platform cloud server 110 may include a processor 115 and accessible data storage 120 such as a database. System 100 may include server application software 125 hosted on platform cloud server 110 and executed by a processor 115 of platform cloud server 110. The server application software 125 may provide any functions or functionality of system 100 as disclosed herein. Server application software 125 may include various modules, components, interfaces, platforms, tools, functions, and applications that may be performed in system 100. As shown in FIG. 1, server application software 125 may provide a plurality of platform functions 128 or features.

In an embodiment, system 100 may include client application software 130, which may be informally referenced as an “app” or “mobile app”, that may be downloaded and installed on, and executable by a processor of, a wireless mobile device 135 (“mobile device”), such as a smartphone or tablet computing device having a processor. In an embodiment, system 100 also may omit downloadable client application software, and a user mobile device 135 may access a web interface of the server application software 125 on the platform cloud server 110 over the Internet via a general purpose browser executable on the mobile device 135 either directly or via an intermediate messaging platform 140, such as a commercially available cloud-based SMS gateway and/or email platform. Such a platform, for example, may be MailChimp or Twilio. System 100 may include a messaging application 145 of the cloud-based messaging platform 140, which may be operable or accessible by functioning of a user mobile device 135 in communication with the intermediate messaging platform 140. System 100 may include a mobile QR code generator, QR code reader, or combined QR code reader and generator 147, of the mobile device 135, which may be downloaded on the mobile device 135 or accessed over a communication network such as via a browser.

System 100 may include a vehicle detection system 150 physically located at a parking facility 155. Vehicle detection system 150 may be located in a fixed gate location 160, such as at an entry gate, exit gate, or both, at parking facility 155. Parking facility 155 may include a plurality of fixed gate locations 160, and system 100 may include a plurality of the parking facility vehicle detection systems 150 each located at a respective fixed gate location 160. System 100 may include a facility QR code generator, QR code reader, or combination QR code generator and code reader 165, co-located with each vehicle detection system 150 at each fixed gate location 160 of the parking facility 155.

System 100 may include a payment gateway 170 accessible over the network 112 by operations of the server application software 125 and platform cloud server 110, client application software 130 and mobile device 135, and/or messaging platform 140. Such an electronic payment system 170 or payment gateway may include, for example, a credit card processing platform, a payments platform, Square, or Paypal, credit card, debit card, Apple Pay, Google Wallet, or any other electronic payment system.

In an embodiment, a computer-implemented system 100 is capable and efficient in performing various objectives desired by consumers and parking facility operators. In an embodiment, the system 100 may function with standard web browser or SMS text messaging application software 110 that may function with a common wireless mobile device 120 such as a smartphone. Such mobile device may include, for example, any version of iPhone or any version of Android, or other smartphone. In an embodiment, system 100 may not require installation of any application software on wireless mobile device. In an embodiment, system 100 may be capable of automatically identifying the parking facility or facility and the gate the customer is trying to enter or exit.

In some embodiments, method 700 and system 100 may be capable to automatically generate and send eTicket(s) to the customer over SMS or by email and eliminate the need for any kind of paper ticket while keeping track of entry time into the facility and the time of stay.

In some embodiments, method 700 and system 100 may be capable to calculate the price based on the pricing rules and time of stay and allow the customer to view and pay the electronic ticket any time. The disclosed methods and systems also may be capable to validate at the exit that the customer has fully paid before opening the exit gate.

In an embodiment, the system 100 may be configured to retrieve prepaid reservations for the parking stay and apply the prepaid amount to the bill. Other embodiments may allow for reservations made directly with the facility or through any third party including but not limited to aggregators and business partners. In an embodiment, system 100 may be configured to to apply any special discounts and promotion codes offered by the parking facility.

In an embodiment, the system 100 may be configured to enable displaying and viewing of an electronic receipt by the customer on the mobile device 135 at any time, or receive the receipt in email. In an embodiment, the system 100 may include a customer web account that may work in all the facilitys that use system 100.

In certain implementations, system 100 may enable the customer to change customer profile, add/remove payment methods, view their usage history, export the electronic receipts for reimbursement and implement additional customer centric features.

In an embodiment, the system 100 may include fixed posted QR code placards on the gates or a QR code display device that is part of the system and deployed by the facility at the gates.

In an embodiment, the system 100 may be configured to dynamically generate QR codes which may be displayed every time a customer drives up to the gate. This may prevent malicious tampering with the system by rogue customers. An embodiment may use geo-location and geo-fencing to validate the customer presence in the facility.

In an embodiment, system 100 may be capable of integration with any gate system and any PARCS system present in the facility. Furthermore, in an embodiment system 100 may function with different Vehicle Detection Systems, such as Wire loop, Wireless Detection system, and/or LPR camera.

In an embodiment system 100 may include a downloadable software application 130, which may be installed on a user mobile device 135.

In an embodiment system 100 may be capable of operating in parking facilities served by valet service. The valet service may be notified when customer checks in by scanning the QR code. System 100 may send an eTicket to customer smartphone 136 after the car is checked into the parking facility 155 by the valet. Customer may view the eTicket, as well as the vehicle damage report submitted by valet at the time of check-in, using the web browser of the mobile device 135. Customer may notify the valet before they return to the facility for valet to get their car ready.

In an embodiment, the system 100 may be capable of various customer centric functions or features. For example, a customer may view and pay the bill using mobile phone 135 in communication with payment gateway 170, add tips for the valet in the bill, and submit any damage claims by operation of the mobile phone 135. In an embodiment, system 100 may be configured to ensure customer privacy and cloud data security.

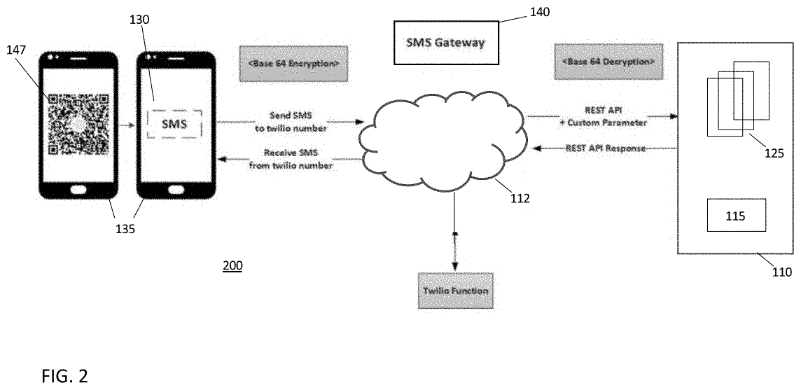

FIG. 2 is a simplified block diagram of a computer-implemented system 200 including messaging (SMS) gateway architecture 210 in an exemplary embodiment. System 200 may be identical, in structure and functions, to system 100 disclosed elsewhere herein, except where a person of ordinary skill would otherwise understand or if differences are required by context. FIG. 2 is a simplified block diagram of system 200 including messaging (SMS) gateway 140 architecture. Referring to FIG. 2, in an exemplary embodiment, the customer mobile device 135 may send the predefined SMS with predefined phone number by scanning the QR code 165. SMS may be sent to Messaging Gateway 140 in the base64 encrypted message. Messaging Gateway 140 may call the backend REST API to check the base64 encrypted message, backend decrypt the base64 message, and send the response through REST API. Once Messaging Gateway 140 receives the success response from the backend or server application software 125, messaging gateway 140 sends the SMS reply back to the user's mobile device 135.

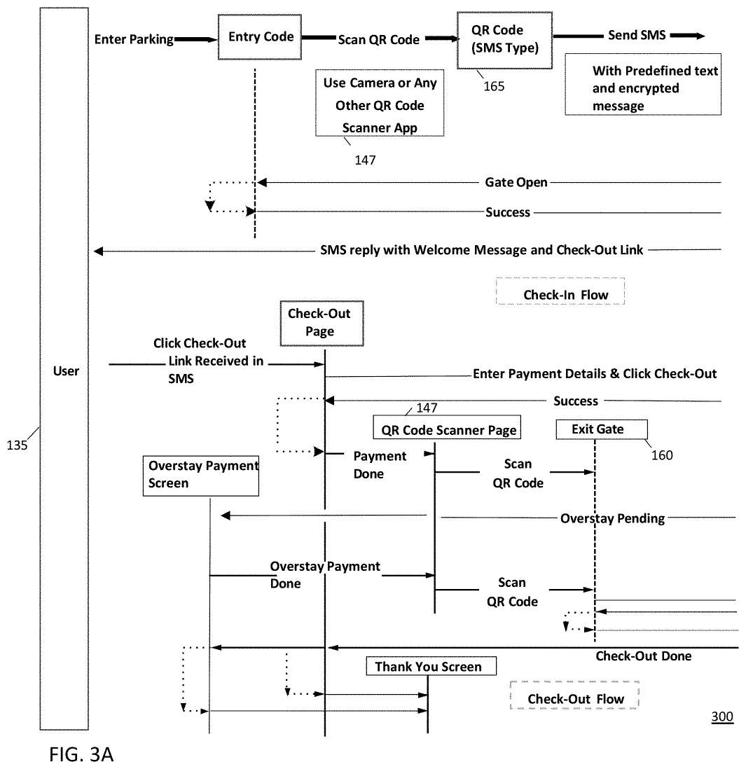

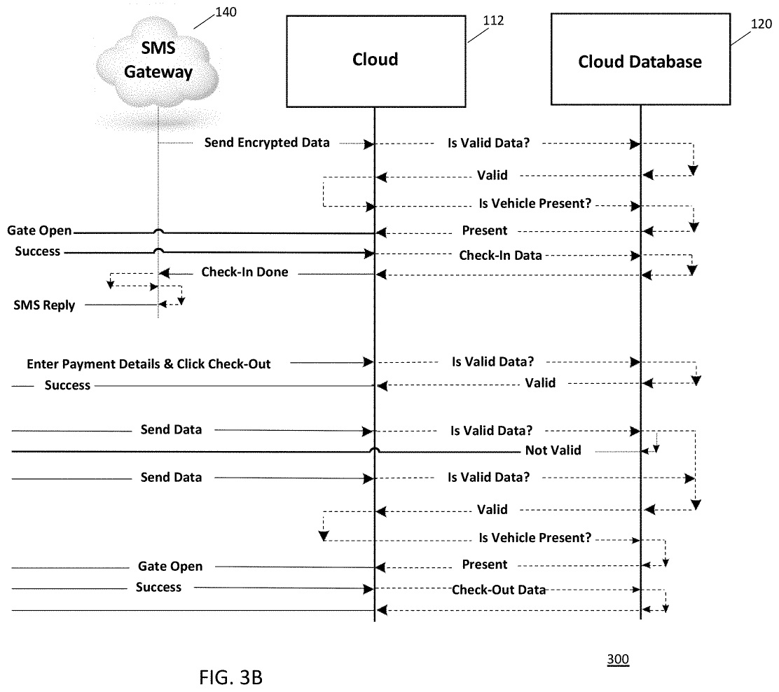

FIGS. 3A and 3B illustrate a simplified flow chart of a computer-implemented system 300 including architecture for direct check-in and check-out using SMS type QR code without prepaid booking, in an exemplary embodiment. System 300 may be identical, in structure and functions, to system 100 disclosed elsewhere herein, except where a person of ordinary skill would otherwise understand or if differences are required by context. Referring to FIGS. 3A and 3B, in embodiments system 300 may include a check-in process, which may further include the following steps. User vehicles entering the entry lane at entry gate 160 in the parking facility 155 are detected by vehicle detection system 150. The vehicle user's mobile device 135 at the entry gate 160 may scan a QR code (SMS type) displayed at the QR code generator 165 located at the entry gate 160 through a QR code scanner enabled camera or any other QR code scanner application of the user's mobile device 135. Once a user mobile device 135 scans the QR code displayed on the QR code generator 165, the default native SMS app 145 may open on the mobile device 135 with a predefined sender number and predefined SMS with an encrypted message. The user's mobile device 135 sends the predefined SMS, and the SMS gateway 140 may send that message to the cloud server 110, and the cloud server may decrypt the SMS message. If the SMS message is validated, and it is verified that the user's vehicle is present at the entry gate 160, the user mobile device 135 may receive the SMS reply from the cloud server 110, with a thank you message and a check-out link generated by the application software 125. On return the user may operate the mobile device 135 to click or select the check-out link received through SMS during check-in.

In continued reference to the exemplary embodiment in FIGS. 3A and 3B, system 100 may provide a check-out process for the returning user to retrieve the user's vehicle, which may include the following. In an embodiment, the system 100 may be capable of enabling the user to select or click the check-out link, which may direct, or present to, the user to a check-out interface or screen on a user display of the mobile device 135. The check-out screen may display the payment details along with check-in/out details. Once a user operates the mobile device 135 to select or click the proceed to check-out button and payment is done, the user may be redirected to the QR code scanner page or screen. The user may be prompted with a message in case of any error. Once a user scans the QR code through a web page or screen, the cloud server 110 may verify the data and check if the vehicle is present at the exit gate, and may open the exit gate by operation of cloud server 110, and may redirect the user to the thank you page.

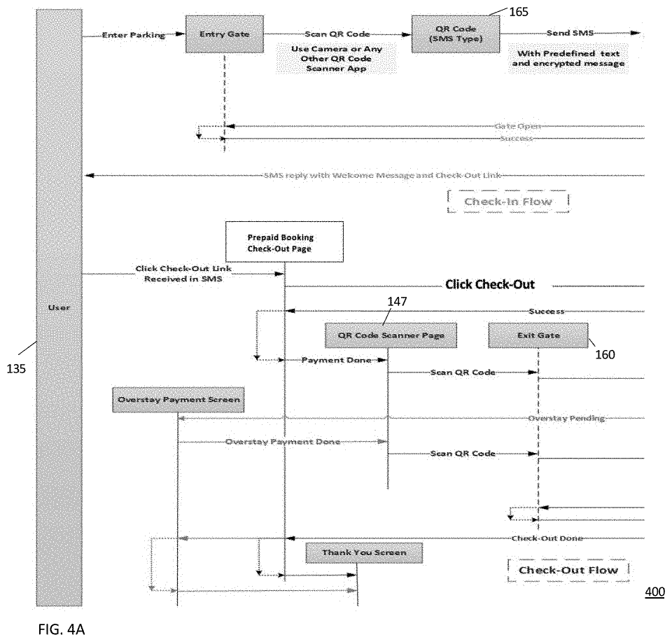

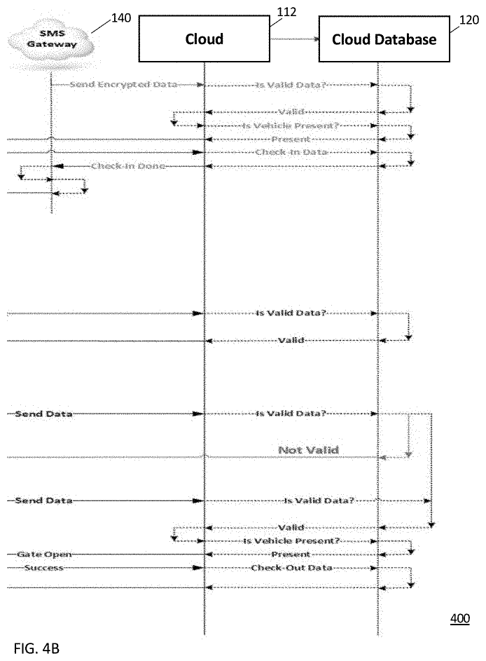

FIGS. 4A and 4B illustrate a simplified flow chart of a computer-implemented system 400 including architecture for direct check-in and check-out using SMS type QR code with prepaid booking, in an exemplary embodiment. System 400 may be identical, in structure and functions, to system 100 disclosed elsewhere herein, except where a person of ordinary skill would otherwise understand or if differences are required by context. Referring to FIGS. 4A and 4B, system 400 may include direct Check-In & Check-Out using SMS Type QR code with prepaid booking, in an embodiment. System 100 may include the following: upon attempting to enter the parking facility 155 in the user's vehicle, the user may operate the wireless device 135 to scan the QR code (SMS type) through QR code scanner 147 enabled camera or other QR code scanner application of the mobile device 135 at the entry gate 150. Once a user scans the QR code, the default native SMS app may open with a predefined sender number and predefined SMS with some encrypted message.

Once a user sends the predefined SMS, SMS gateway may send that message to cloud server 110 and the cloud server 110 may decrypt that message. If the message is validated and if the user's vehicle is present at the entry gate 160 the user may receive the SMS reply with thank you message and check-out link. The checkout process in this exemplary embodiment may include the following steps. User reaches the exit gate 160 after some period of time. User operates wireless device 135 to click or select the check-out link received through SMS during check-in. Once the user clicks the Check-out link, user may be redirected to the check-out page displayed on user's wireless device 135. The Check-Out page may display the prepaid booking details along with check-in/out details. Once a user clicks the proceed to check-out button user may be redirected to the QR code scanner page or screen. User may be prompted with a message in case of any error.

Once a user scans the QR code through a web page or screen, the cloud server may verify the data If there is any overstay amount pending, the user may redirect to the payment screen where it may show the balance or overstay amount. Once the server has verified the payment, user may be again redirected to the QR code scanner screen. Once again, the user scans the QR code through a web page or screen, the cloud server may verify the data and check if the vehicle is present at the exit gate, gate may open through the cloud server and the user may be redirected to the thank you page.

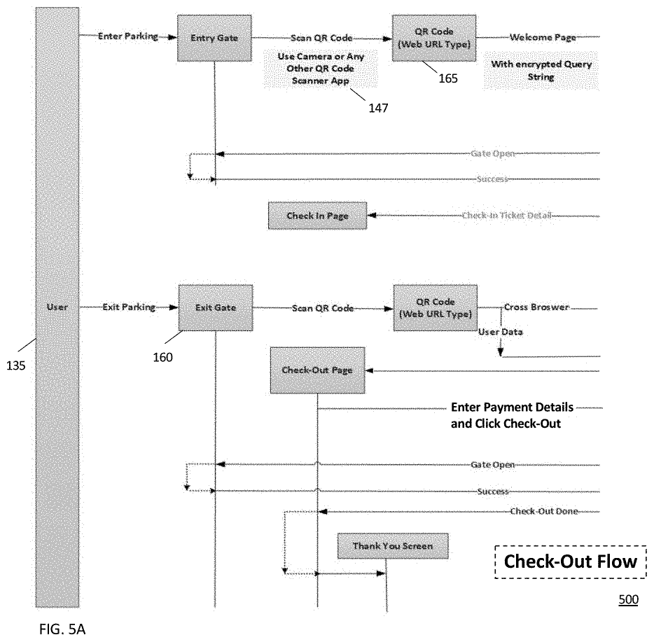

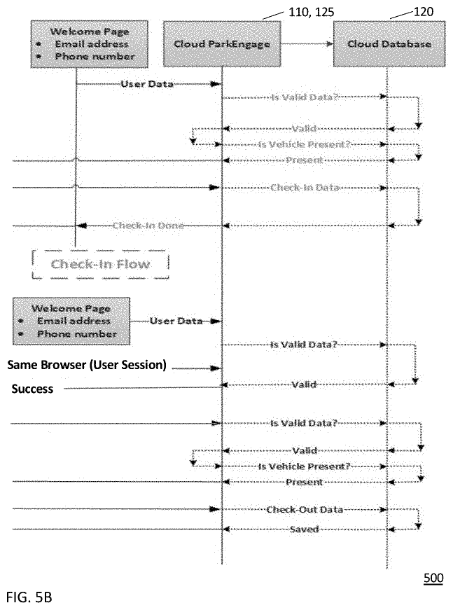

FIG. 5 which shows the architecture for Direct Check-In & Check-Out using Web URL Type QR Code without prepaid booking, the check-in may comprise of the following. System 500 may be identical, in structure and functions, to system 100 disclosed elsewhere herein, except where a person of ordinary skill would otherwise understand or if differences are required by context. User may enter into the parking. User may scan the QR code (URL type) through QR code scanner enabled Camera or any other QR Code scanner app at the entry gate. Once a user scans the QR code and clicks the link, the default browser may open with a predefined URL and encrypted query string. URL may open the Welcome page with input fields email and phone number. Once a user enters a phone number and email and clicks the submit button, the cloud server may verify the data and check if the vehicle is present at the exit gate, gate may open through the cloud server and the user may redirect to the Check-In page details.

Similarly, in this exemplary embodiment, the check-out process may include operating the mobile device 135 to utilize a web link for checking out. At the exit gate 160, the check-out link received through email during check-in is selected by operating the mobile device 135. The Check-out link may redirect the mobile device 135 of the user to the check-out screen. Mobile device 135 may display the Check-Out screen with the payment details and check-in/out details.

Once a user clicks the proceed to check-out button and payment is done, the user may operate the mobile device 135 to redirect to the QR code scanner page or screen. The user may prompt a message in case of any error. When the user operates the mobile device 135 to scan the QR code through a web page or screen, cloud server 110 may verify the data and determine whether the user's vehicle is present at the exit gate. The cloud server 110 may open the exit gate and redirect the user's mobile device 135 to the thank you page.

In an embodiment, system 100 may be configured to enable check-out by the user operating the mobile device 135 with a QR code displayed by QR code generator 165, instead of a web link. In an embodiment, system 100 may be configured to enable operation of the mobile device 135 at the exit gate 160 to scan the QR code (URL type) displayed on the QR code generator 165 using the QR code scanner enabled camera or other QR code scanner application 147. When the mobile device 135 scans the displayed QR code and selects the embedded link, the default browser of the mobile device 135 may open to a predefined URL and encrypted query string. If validated, the browser at the URL may open a welcome page with input fields such as email and phone number, or otherwise open a check-out screen. If a user operates the mobile device 135 to click or select the submit button on the welcome page, then also the check-out page may open on the display of the mobile device 135. The Check-Out screen may display payment details along with check-in/out details. Once a user clicks the proceed to check-out button and payment is complete, the cloud server 110 may verify the data and check if the user's vehicle is present at the exit gate 160, which may be opened by the operation of the cloud server and server application software 125.

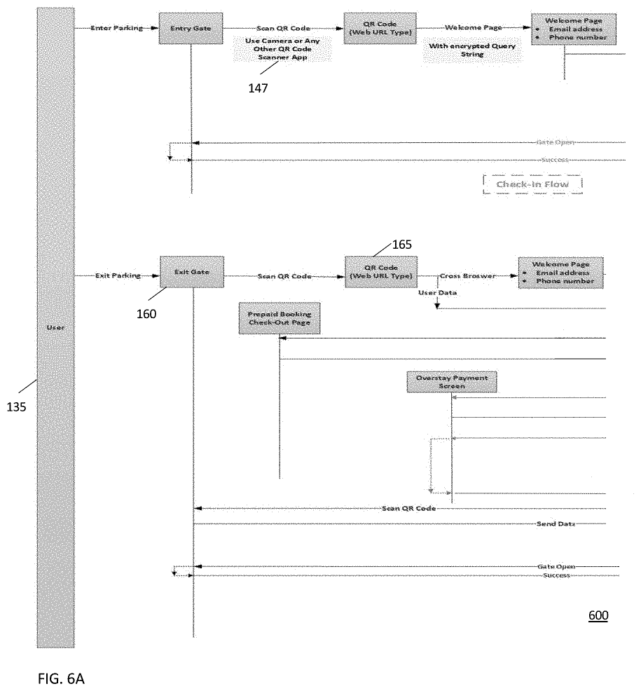

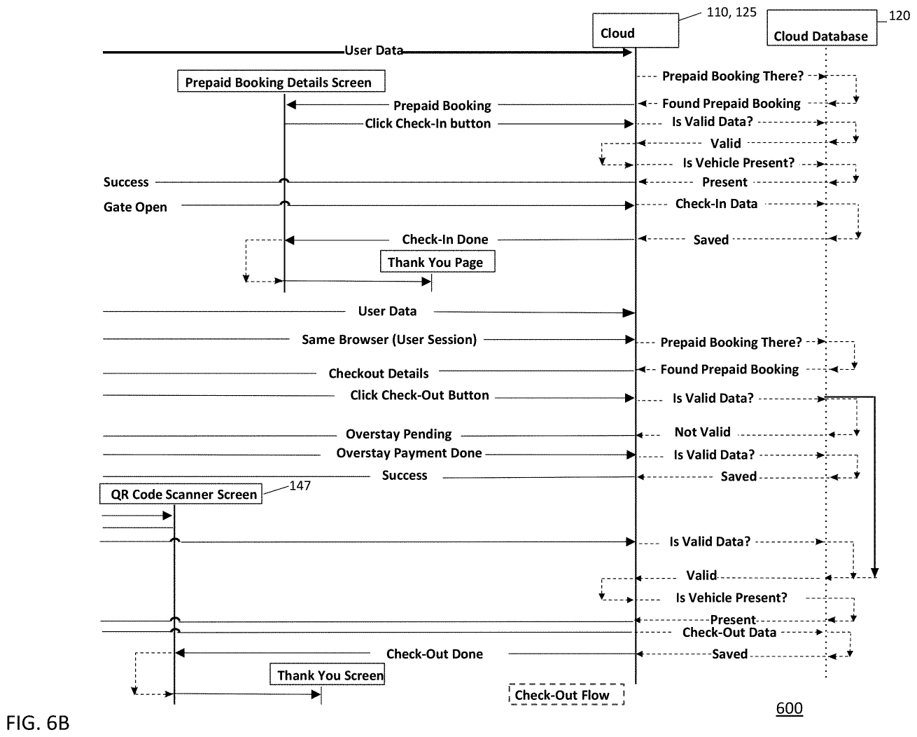

FIGS. 6A and 6B illustrate in a flow chart form a system 600. System 600 may be identical, in structure and functions, to system 100 disclosed elsewhere herein, except where a person of ordinary skill would otherwise understand or if differences are required by context. User may enter into the parking. The steps for check in this embodiment may include the steps of a user entering into the parking. User may scan the QR code (URL type) through QR code scanner enabled camera or any other QR code scanner app of the wireless device 135 at the entry gate.

Once a user operates the mobile device 135 to scan the QR code and select the link, the default browser may open with a predefined URL and encrypted query string. The URL may open the welcome page with input fields email and phone number. Once the user enters the phone number and email and clicks the submit button, the user may redirect to the Check-In page details with prepaid booking details. On the Check-In page user may click on the Proceed to Check-In button and the cloud server 110 may verify the data and check if the vehicle is present at the exit gate 160. The exit gate 160 may be opened by cloud server 110.

Similarly, for the check-out process the steps may include the following: user reaches the exit gate after some period of time. User scans the QR code (URL type) through QR code scanner enabled Camera or any other QR Code scanner app at the exit gate.

Once a user scans the QR code and clicks the link, the default browser may open with a predefined URL and encrypted query string. If it's a cross browser then URL may open the Welcome page with input fields email and phone number otherwise Check-Out Screen with prepaid booking details may be open. If a user clicks the submit button on the welcome page, then also the Check-Out page with prepaid booking details may open.

Once a user clicks the proceed to check-out button, Platform cloud server may verify the data If there is any overstay amount pending, the user may redirect to the payment screen where it may show the balance or overstay amount. Once the server is verified the payment user may again redirect to the QR code scanner screen. If there is no overstay pending Platform cloud server may check if the vehicle is present at the exit gate, gate may open through Platform cloud server and the user may redirect to the thank you page

In case of overstay, once again, the user scans the QR code through a web page or screen, Platform cloud server may verify the data and check if the vehicle is present at the exit gate, gate may open through Platform cloud server and the user may redirect to the thank you page.

Alternatively, in an embodiment, the check-out process may be accomplished by using a weblink whereas the steps may include the following actions: user reaches the exit gate after some period of time. User clicking the check-out link received through email during check-in.

Once a user clicks the Check-out link user may redirect to the check-out screen with prepaid booking details. Once a user clicks the proceed to check-out button, Platform cloud server may verify the data If there is any overstay amount pending, the user may redirect to the payment screen where it may show the balance or overstay amount. Once the server is verified the payment user may again redirect to the QR code scanner screen. If there is no overstay pending Platform cloud server may check if the vehicle is present at the exit gate, gate may open through the platform cloud server and the user may redirect to the thank you page

Once again, the user scans the QR code through a web page or screen, Platform cloud server may verify the data and check if the vehicle is present at the exit gate, gate may open through the platform cloud server and the user may redirect to the thank you page.

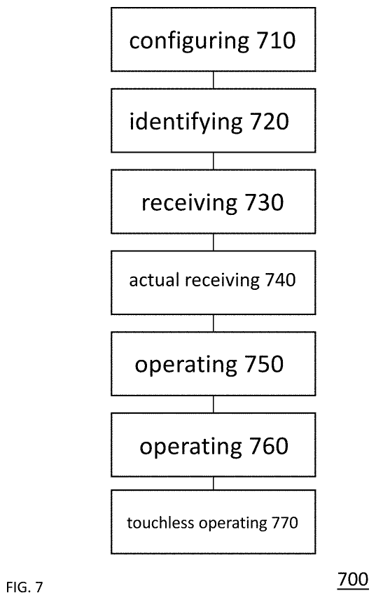

FIG. 7 is a simplified flow diagram showing a computer-implemented method 700 for touchless parking entry, payment and exit from a parking facility. Method 700 may be identical in function, to steps and processes performed by operations of system 100 disclosed elsewhere herein, except where a person of ordinary skill would otherwise understand or if differences are required by context. Computer-implemented method 700 may include: configuring 710 platform application software executable by the processor of a cloud platform server to close an access control gate to prevent a subject vehicle from exiting a secured vehicle parking facility at said access control gate unless an exit condition is satisfied, the exit condition comprising:
identifying 720 to determine whether the subject vehicle is identical to an earlier entering vehicle in the secured vehicle parking facility,
receiving 730 an exit request for the subject vehicle to physically exit the secured vehicle parking facility through said access control gate, and
actual receiving 740 of payment for a parking fee calculated for parking the subject vehicle during the period from entry of the earlier entering subject vehicle until said exit request;
   operating 750 a QR code generator at said access control gate to display a QR code to present an exit request for the subject vehicle to physically exit a secured vehicle parking facility through said access control gate;
   operating 760 a touchless vehicle detection system to determine identity of the subject vehicle in relation to an earlier entering vehicle in the secured vehicle parking facility; and touchless operating 770 a mobile device to perform a QR code scanning application to scan a QR code displayed by said QR code generator at said access control gate, to initiate said exit request.

The methods and systems discussed here include a cloud-based system accessible through the internet from an end user's mobile device (smart phone or tablet). The end user initiates entry into the parking facility, either by accessing their existing e-ticket (if they have a pre-paid reservation) or by using their smart device camera to scan a QR code at the entry to the facility (if they do not have an existing e-ticket for a pre-paid reservation).

When they have scanned the QR Code, this may initiate the check-in process to the facility and open the gate if it is a gated facility or notify the valet if it is a valet facility. If the end-user does not have an existing e-ticket for a pre-paid reservation, the system may create that e-ticket; in either case, a link to that e-ticket (pre-existing or newly created) may be sent to the end-user's device in an SMS text message for future access when paying or exiting. Each of these steps is described in detail below.

All of the functions of the cloud system may be initiated through an API call and so the functionality described below may be incorporated into a mobile app or other system or technology to initiate the behavior specified. Part of the disclosed subject matter is a mobile responsive website which provides a universal user interface to the end-user and this mobile responsive website also calls the cloud system's APIs to elicit the behavior described below.

Further discussion of the various elements is provided below for clarity.

### Initial Entry to the Facility

Initial entry to the facility is granted by the user scanning a QR Code at the entry point using the camera on their smart device. This requires the end-user's smart device camera to be enabled for the scanning of QR Codes. When the QR Code is scanned, an SMS message may be composed automatically on the end-user's smart device; this SMS text message may be directed to a phone number associated to the parking operator which operates the facility they are attempting to enter and the body of the text message may be an string is ascii characters encoding the date/time, the facility, and the entry point of the facility. The customer must press send on the SMS text message to check-in to the facility and create the e-ticket if one does not already exist (in the case of a pre-paid reservation).

If the end-user experiences any difficulty entering the facility as described, the administrative console (see below) also provides a facility administrator with the ability to open the gate for the end-user and to initiate the creation of the e-ticket which may be sent to the end-user via SMS text message.

### Composition and Display of the QR Code

The QR Code will, at a minimum, be composed to include the facility identification and the entry point identification within that facility. For this basic composition of QR Code, the QR Code may be preprinted on a placard that is mounted at the entry point of the facility that it is identifying.

Another embodiment of a more secure premium version may have a smart digital display device located at the gate, that may light up when the vehicle is detected in the lane, it may display the dynamically generated QR code, customer may scan that code with the phone camera App and once the car moves out of the lane display may go blank till the new car comes back and that's when it may show a new QR code. Smart Display may either be connected to the Platform cloud over the Internet, where the code may be generated in the cloud and pushed to the Display, alternatively the display may work in disconnected mode and may have a proprietary logic built in the Smart Display device to generate unique QR code that platform cloud server 125 may be able to decode.

A more secure version of the QR Code may be composed as above but also include the date/time that the QR was generated and a random number that falls within a range of numbers that is identified with the particular facility and entry point that the QR Code is identifying. In this case, the QR Code may be generated by and display on an electronic smart display that is mounted at the facility entry point which it identifies.

This more secure version of the QR Code may be used to prevent an end-user from sending a duplicate SMS message to trigger a check-in when they are not physically present at the facility entry point.

At the time of setup of these Smart Display Devices in each facility entry and exit lane, unique facility name and specific gate code may be fed into the device through a touchscreen, the built in logic may use these two pieces of information to generate the unique QR code which may also use the timestamp every time to make it a unique QR code. During setup the QR code may be sent to Platform cloud via SMS, this first text may be used to calibrate the cloud with the device.

Once setup is completed the Smart Display Device may be ready to use to display the QR codes whenever a vehicle is detected in the entry or exit lane where the display device is deployed.

### Creation of the E-Ticket

When a validated SMS text message is received, the cloud system may identify the facility, entry point, date/time, and end-user phone number and may first search for a pre-existing e-ticket that may exist for that end-user for that facility for the same date that has been pre-paid. If no such e-ticket is found within the cloud system database, then a new e-ticket may be created for this stay for this end-user at this facility. The e-ticket may be uniquely identified with a ticket number and may be stored in the cloud system's database.

In either case of a new e-ticket or a pre-existing e-ticket, an SMS message may be sent back to the end-user's phone number that may include a link to the e-ticket on the cloud system's webserver.

As previously noted, the administrative console also may provide this functionality to a facility administrator to be able to create the e-ticket on behalf of the end-user in case of any end-user difficulty in entering the facility. The administrator may also resend the e-ticket to the end-user at any time if the user should lose access to their original e-ticket.

### Checking in the Customer

After the e-ticket has been created and sent via SMS to the end-user, the end-user may be checked into the facility. Depending on the facility as either a gated, self-service facility or a valet parking facility, the system may either open the entry gate to enable the user to enter, or may notify the valet of the end-user's presence to be valet parked.

Again, a facility administrator may also check in the end-user on an e-ticket using the administrative console described below

### Opening the Gate to a Gated Facility

The cloud system may be enabled to open the gate of a gated facility by calling an API that is provided by the gate vendor. This API may be accessible over the internet from the cloud system and each gate vendor may have their own proprietary API to open the gate. The proper API for the cloud system to use may be specified for each entry point to each facility so that any facility may take advantage of different gate equipment for each entry and may change their gate equipment over time.

The gate system may or may not also have an associated vehicle presence detection system (wire-loop or other detection system). If such a system is to be used by the cloud system, the vendor may also provide their internet accessible API for detecting whether or not a vehicle is present. As with the gate API, this API may be specified within the cloud system for each facility entry point and any facility may have vehicle detection system from different vendors with different APIs.

If such a system is present, the cloud system may first check for the presence of a vehicle prior to searching for an e-ticket, creating and e-ticket, opening the gate, or notifying the valet. All of these actions may only be enabled, at an entry point which has a vehicle detection system, when a vehicle is detected.

As noted previously, a facility administrator may also open the gate at any time via the administrative console described below. In this case, the administrator may also see the vehicle detection system status for each entry and exit point for all entry and exit points that have a vehicle detection system installed and configured within the cloud system. However, a facility administrator using the administrative console may open any gate at any time whether the vehicle detection system is currently detecting vehicle presence or not.

Accessing the E-Ticket for Payment or Exit from the Facility

When the end-user has parked their vehicle in the parking facility or turned their vehicle over to the valet if a valet facility, the end-user may access the e-ticket at any time by clicking on the link to the e-ticket in the SMS message that was sent to their smart device.

When they have accessed their e-ticket in this way, there are multiple functions that the end user may perform and the availability of each of these functions may vary from one facility to another depending on the services that are offered by each facility:
a. End-user may specify the parking location of their vehicle or the valet location to retrieve their vehicle from.
b. End-user may update their profile information including their phone number, vehicle identifying information (make, model, year, type, license plate number, etc.), address information, payment method information, expected return time.
c. End-user may request additional services from the parking operator if the operator offers such services. The services that the end-user may request may be enumerated within the cloud system for each facility separately and for each service there may or may not be an additional price associated with each service—these things may all be specified by the operator while setting up the cloud system. For example, the parking operator may offer car washing and detailing services, vehicle inspection services, vehicle maintenance services, concierge services, etc. at the operator's discretion.
d. The end-user may notify the valet, in the case of a valet facility, of their updated return time in order for the valet to have their vehicle ready and waiting for them upon return.
e. The end-user may pay for their current parking charges at any time using an electronic payment method that may include credit card, google pay, apple pay, electronic bank transfer, promotional codes, customer account credits.
f. The end-user, when at a facility exit point, may access the e-ticket for the purpose of checking out of the facility.

A facility administer may access all of these same functions on an end-user's behalf should the end-user have any difficulty with using any of the functionality by accessing the administrative console described below.

### Exiting the Facility

When the end-user accesses their e-ticket and selects the check-out functionality, the cloud system may first check whether or not the end-user has fully paid whatever fees are due for parking and other services that have been ordered. If there is any amount owing, then the end-user may be prompted to pay their parking and other fees prior to enabling exist from the facility or notification of the valet (in the case of a valet facility).

Once full payment has been verified, the e-ticket may open the camera on the end-user's smart device and request them to point the camera at the QR Code at an exit point. When the end-user camera scan's the QR Code at the exit point, the cloud system may verify once again that the user has paid all fees and request payment if any fees are due. If there is no amount owing, the vehicle detection system, if setup for this exit point, may be checked for the presence of a vehicle and if vehicle is present, the cloud system may call the API to open the gate if it is a gated facility. Finally, the cloud system may mark the e-ticket as having been checked out with the date and time stamp and the e-ticket may be marked as closed.

This function may also be accessible to a facility administrator using the administrative console described below to enable facility exit for the end-user should the end-user have any difficulty with accessing this functionality.

### Administrative Console

All of the functionality described above may be available to a facility administrator via the web based administrative console provide as part of the system as described above.

In addition, this administrative console may provide a facility administrator with additional capabilities that are not part of the end-user functionality including the following functions.
a. Cloud System Configuration—all system set up and configuration details may be configured through the administrator console.
b. All end user functionality—administrator may invoke any end-user functionality on behalf of a particular end-user should the end-user have any difficulty accessing any of the functionality themselves.
c. Monitoring and Management—all data within the cloud system may be monitored and managed by a facility administrator via the administrative console. This includes access to e-tickets, monitoring of the status of vehicle detection system, monitoring and control of individual gates.
d. Reporting—reporting of transaction details and summaries are available through the administrative console as well as all other cloud system activities including end-user entries and exits, end-user service requests, payments owning or paid, etc.
e. Business Intelligence—a variety of business metrics and analytics are available through the administrative console.

Apparatus, methods and systems according to embodiments of the disclosure are described. Although specific embodiments are illustrated and described herein, it may be appreciated by those of ordinary skill in the art that any arrangement which is calculated to achieve the same purposes may be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art may appreciate that implementations may be made for other fields of art, systems, apparatus or methods that provide the required functions. The disclosed subject matter should therefore not be limited by the above described embodiment, method, and examples, but by all embodiments and methods within the scope and spirit of the disclosed subject matter.

In particular, one of ordinary skill in the art will readily appreciate that the names of the methods and apparatus are not intended to limit embodiments or the disclosure. Furthermore, additional methods, steps, and apparatus may be added to the components, functions may be rearranged among the components, and new components to correspond to future enhancements and physical devices used in embodiments may be introduced without departing from the scope of embodiments and the disclosure. One of skill in the art will readily recognize that embodiments are applicable to future systems, future apparatus, future methods, and different materials.

All methods described herein may be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

Terminology used in the present disclosure is intended to include all environments and alternate technologies that provide the same functionality described herein.

1. A computer-implemented system to control access by a subject vehicle to a secured vehicle parking facility, said system comprising:
a platform cloud server comprising a processor;
platform application software executable by the processor of the platform cloud server, the platform application software configured to control an access control gate to prevent a subject vehicle from exiting a secured vehicle parking facility at said access control gate unless an exit condition is satisfied, the exit condition comprising:
a determination that the subject vehicle is identical to an earlier entering vehicle in the secured vehicle parking facility,
receipt of an exit request for the subject vehicle to physically exit the secured vehicle parking facility through said access control gate, and
actual receipt of payment for a parking fee calculated for parking the subject vehicle during the period from entry of the earlier entering subject vehicle until said exit request; and
said platform cloud server receiving said exit request via an automated SMS message initiated by touchless scanning of a QR code displayed to identify said access control gate, by operation of a QR code scanning application of a mobile device.

2. The computer-implemented system of claim 1, further comprising:
said platform cloud server receiving confirmation of said actual receipt of payment via an automated communication from an electronic payment platform in relation to touchless initiation of electronic payment.

3. A computer-implemented method comprising:
configuring a platform application software executable by a processor of a cloud platform server to control an access control gate to prevent a subject vehicle from exiting a secured vehicle parking facility at said access control gate unless an exit condition is satisfied, the exit condition comprising:
identifying to determine whether the subject vehicle is identical to an earlier entering vehicle in the secured vehicle parking facility,
receiving of an exit request for the subject vehicle to physically exit the secured vehicle parking facility through said access control gate, and
actual receiving of payment for a parking fee calculated for parking the subject vehicle during the period from entry of the earlier entering subject vehicle until said exit request;
displaying a QR code to identify said access control gate to scan by touchless operation of a QR code scanning application of a mobile device to generate an exit request for the subject vehicle to physically exit a secured vehicle parking facility through said access control gate;
operating a touchless vehicle detection system to determine identity of the subject vehicle in relation to an earlier entering vehicle in the secured vehicle parking facility; and
executing said exit request to open said access control gate.

4. A non-transitory computer-readable medium having tangibly embodied thereon and accessible therefrom processor-executable instructions that, when executed by at least one data processing device of a data processing system, causes said at least one data processing device to perform a method comprising:
configuring platform application software executable by the processor of a cloud platform server to control an access control gate to prevent a subject vehicle from exiting a secured vehicle parking facility at said access control gate unless an exit condition is satisfied, the exit condition comprising:
identity of the subject vehicle is identical to an earlier entering vehicle in the secured vehicle parking facility,
receipt of an exit request for the subject vehicle to physically exit the secured vehicle parking facility through said access control gate, and
actual receipt of payment for a parking fee calculated for parking the subject vehicle during the period from entry of the earlier entering subject vehicle until said exit request;
operating a QR code generator at said access control gate to display a QR code to present an exit request for the subject vehicle to physically exit a secured vehicle parking facility through said access control gate; and
operating a touchless vehicle detection system to determine identity of the subject vehicle in relation to an earlier entering vehicle in the secured vehicle parking facility.

5. The computer-implemented system of claim 1, further comprising:
the QR code displayed on a QR code generator to identify said access control gate.

6. The computer implemented method of claim 4, further comprising:
said displaying said QR code further comprising the step of generating said QR code by operation of a QR code generator to identify said access control gate.

7. A computer-implemented system comprising:
a platform cloud server comprising a processor;
a platform application software executable by the processor of the platform cloud server, the platform application software configured to control an access control gate to control a subject vehicle access to a secured vehicle parking facility at said access control gate;
said platform cloud server receiving an entry request via an automated SMS message initiated by touchless scanning of a QR code displayed to identify said access control gate, by operation of a QR code scanning application of a mobile device;
said platform cloud server creating a virtual link between said subject vehicle and said mobile device;
said platform cloud server sending a payment link to said mobile device; and
a receipt of a payment by said platform cloud server, said payment initiated through the use of said payment link.

8. The computer implemented system of claim 7, further comprising:
said platform cloud server receiving an exit request via a second automated SMS message initiated by touchless scanning of said QR code displayed to identify said access control gate by operation of a QR code scanning application of said mobile device for the subject vehicle to physically exit the secured vehicle parking facility through said access control gate after said receipt of said payment.

9. A computer-implemented method comprising:
configuring a platform application software executable by a processor of a cloud platform server to control a subject vehicle access to a secured vehicle parking facility at said access control gate;
displaying a QR code to identify said access control gate;
receiving an entry request by touchless scanning of said QR code by a scanning application of a mobile device to generate said entry request for the subject vehicle to physically enter said secured vehicle parking facility through said access control gate;
creating a virtual link between said subject vehicle and said mobile device and storing said virtual link;
sending a payment link to said mobile device; and
fulfilling said entry request by opening said access control gate.

10. The computer-implemented method of claim 9 further comprising:
the steps of:
receiving a payment, said payment initiated through the use of said payment link.

11. The computer-implemented method of claim 10, further comprising:
the steps of:
receiving an exit request by touchless scanning of said QR code by the scanning application of said mobile device to generate said exit request for the subject vehicle to physically exit said secured vehicle parking facility through said access control gate;
verifying the receipt of said payment; and
fulfilling said exit request by opening said access control gate if verification is successful.
